(19) United States
(12) Patent Application Publication
(10) Pub. No.: US 2025/0250488 A1
(43) Pub. Date: Aug. 7, 2025

(54) FOLIAR WETTING ENHANCEMENT BY AN ALKOXYLATED ALCOHOL

(71) Applicant: Stepan Company, Northbrook, IL (US)

(72) Inventors: Mona Marie KNOCK, Barrington, IL (US); Gregory P. DADO, Chicago, IL (US)

(21) Appl. No.: 18/432,482

(22) Filed: Feb. 5, 2024

(51) Int. Cl. C09K 23/38

(52) U.S. Cl. CPC C09K 23/38

(57) ABSTRACT

A composition comprising:
(a) 0.1 to 30.0 wt. % of a surfactant;
(b) 0.5 to 90.0 wt. % of an active selected from herbicides, fungicides, insecticides or nematicides;
(c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and
(d) 1.0 to 95.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

### FIELD OF THE INVENTION

The invention relates to low-mole alkoxylate/surfactant-containing compositions having improved wetting capabilities for hydrophobic foliar surfaces, which exhibit low foam and enhanced stability in agricultural spray applications.

### BACKGROUND OF THE INVENTION

Surfactants, in particular nonionic surfactants, are important components in agriculture formulations, where they function as wetting agents for hydrophobic surfaces. Such formulations are designed to improve the performance and efficiency of agricultural active components such as herbicides, fungicides, insecticides and nematicides in spray applications. These formulations should optimally not only provide sufficient wetting capability but possess enhanced stability consistent with the rigors of commercial use. Most nonionic surfactants have a combination of polar and nonpolar segments that allow them to function effectively as surfactants. However, many common nonionic surfactants are less effective than desired as wetting agents, and some, e.g., higher mole alcohol ethoxylates, wet hydrophobic surfaces only with difficulty. So-called “extended” nonionic surfactants are known in which the hydrophobic portion, usually an alkyl group, is directly bonded to one or more oxypropylene (PO) units, followed by a cap of four or more oxyethylene (EO) units. See, for example, U.S. Pat. No. 9,303,240 or U.S. Publ. No. 2019/0099720. The surfactants are suggested as an environmentally friendly alternative to nonylphenol ethoxylates.

Combinations of ethoxylated alcohol surfactants with a minor proportion of free fatty alcohols can in some cases improve a nonionic surfactant's ability to wet a hydrophobic surface. For instance, P. Phaodee et al. (J. Surfact. Deterg. 22 (2019) 1175) showed that including a linear (non-alkoxylated) C₆-C₉ alcohol as an additive with a C₁₀-C₁₆ alcohol 7EO ethoxylate reduced the contact angle on solid coconut oil from about 48 degrees to 33-44 degrees (see Table 2 of Phaodee). Despite the apparent improvement in wettability shown in the article, the presence of free fatty alcohol can have undesirable consequences such as: (1) reduced water solubility, thereby straining the overall solubilization load on the formulation and potentially resulting in separation or undesired deposition of oily droplets on surfaces to be wetted; (2) a measurable disturbance of the interfacial tension (IFT) or cloud point of the formulation; (3) disruption of micellar aggregation of the surfactant.

The industry would benefit from low-mole alkoxylate/surfactant compositions with an improved ability to wet nonpolar surfaces in agricultural applications, while also possessing excellent stability.

### SUMMARY OF THE INVENTION

In one embodiment, the current invention relates to a composition comprising: (a) 0.1 to 30.0 wt. % of a surfactant; (b) 0.5 to 90.0 wt. % of an active selected from herbicides, fungicides, insecticides or nematicides; (c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and (d) 1.0 to 95.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Another embodiment relates to a method for producing a sprayable composition comprising diluting the above composition by at least 50% with water.

Still another embodiment relates to a method comprising applying the above sprayable composition to foliar surfaces, soil, or plant roots.

In another embodiment, the current invention relates to a composition comprising: (a) 10.0 to 85.0 wt. % of a surfactant; (b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and (c) 10.0 to 70.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Another embodiment relates to a method for combining the above composition with an active selected from herbicides, fungicides, insecticides or nematicides to produce a sprayable composition, and optionally dilute the composition with water.

Still another embodiment relates to a method comprising applying the above sprayable composition to foliar surfaces, soil, or plant roots.

Another embodiment relates to a method comprising forming a mixture by combining: (a) 0.1 to 30.0 wt. % of a surfactant; (b) 0.5 to 90.0 wt. % of an active selected from herbicides, fungicides, insecticides or nematicides; (c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and (d) 1.0 to 95.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Another embodiment relates to a method comprising forming a mixture by combining: (a) 10.0 to 85.0 wt. % of a surfactant; (b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and (c) 10.0 to 70.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

We found that solutions comprising a low-mole alkoxylate and nonionic surfactant wet hydrophobic surfaces more effectively than solutions comprising only the nonionic surfactant. The low-mole alkoxylates are low-to no-foam surfactants that can boost wetting performance in situations that require low-foaming surfactants, such as agricultural spray applications.

### BRIEF DESCRIPTION OF THE DRAWINGS

FIG. 1 is a photograph of a series of experimental samples containing low-mole alkoxylate/surfactants immediately after low temperature storage to demonstrate stability. From left to right, the photographs illustrate Control Example 1 and Examples 6, 4, 5, 3.

### DETAILED DESCRIPTION OF THE INVENTION

### Compositions

In some aspects, the invention relates to compositions comprising combinations of surfactants, low mole alkoxylates, solvents and actives for use in agricultural applications. Such compositions are commercially available in two formulation types. First, the so-called in-can formulation includes the agricultural active and delivery system. Second, tank-mix formulations include only the delivery systems, where the active formulations are mixed in separately. Both compositions are typically diluted with water and ultimately applied to foliar surfaces, soil, or plant roots. Preferably, the compositions are applied by spraying, and provide improved wetting of hydrophobic surfaces. The compositions possess enhanced stability as demonstrated by pour point and freeze point.

### Surfactant

The surfactant can be selected from nonionic, anionic or amphoteric surfactants or mixtures thereof.

### Nonionic Surfactant

In some aspects, the nonionic surfactant is selected from alkoxylated alcohols, fatty alcohol ethoxylates, ethoxylated alkanolamides, ethoxylated alkylphenols, ethoxylated styrylphenols, fatty amine ethoxylates, EO/PO block copolymers, ethoxylated castor oils, methyl ester ethoxylates, alkylpolyglucosides, polysorbates, fatty acid ethoxylates or mixtures thereof. Modified versions of these classes of nonionic surfactants can also be used. Thus, one or more terminal hydroxyl groups of the nonionic surfactants can be converted or capped as halide, ether, ester, or other suitable functionalities according to well-known methods.

In a preferred aspect, the nonionic surfactant is an alkoxylated alcohol. The alkoxylated alcohol preferably has a C₈-C₁₆ alkyl chain and one or more oxyethylene (EO) groups, oxypropylene (PO) groups, or combinations of these. The oxyalkylene units can be arranged in block, multiblock, or random configuration.

In some aspects, the alkoxylated alcohol has the formula:

R¹—O-(AO)_{q}H

In the formula, R¹ is a linear or branched C₈-C₁₆ alkyl group, AO is oxyethylene, oxypropylene, or a combination thereof, and q has an average value within the range of 3 to 50. In some preferred aspects, AO is oxyethylene and q has an average value within the range of 5 to 20. In other preferred aspects, AO is oxyethylene, R¹ is a linear or branched C₉-C₁₃ alkyl group, and q has an average value within the range of 5 to 20. Suitable for use are nonionic surfactants that comprise broad or narrow ranges of product distributions that result from the catalyst selection and/or reactant proportions used in the manufacturing of the nonionic surfactants, as is well known to those skilled in the art. The alkoxylated alcohol can also include mixtures of the alkoxylated alcohol of the above formula.

Suitable nonionic surfactants are commercially available from Stepan Company and other suppliers. Suitable Stepan nonionic surfactants include those, for example, sold under the MAKON®, BIO-SOFT®, NINOL®, STEPANTEX®, PETROSTEP®, POLYSTEP®, STEP-FLOW®, NINEX®, TOXIMUL®, and IGEPAL® marks, especially the ethoxylated alcohols and other products sold under the BIO-SOFT® and MAKON® marks. Examples include BIO-SOFT® N91-6, BIO-SOFT® N1-5, BIO-SOFT® N91-6, BIO-SOFT® N91-8, BIO-SOFT® N25-7, MAKON® DA-9, MAKON® TD-9, MAKON® TD-12, MAKON® TD-18, MAKON® NF-180, STEPASOL® DG, MAKON® UD-8, and the like.

### Anionic Surfactants

When present, the anionic surfactants can be selected from dodecylbenzene sulfonic acid, calcium dodecylbenzene sulfonic acid, sodium dodecylbenzene sulfonic acid, isopropylamine dodecylbenzene sulfonic acid, triethanolamine dodecylbenzene sulfonic acid, diethanolamine dodecylbenzene sulfonic acid, sodium dioctyl sulfosuccinate, phosphate esters, tallow amine ether sulfates, sodium olefin sulfonate, sodium alkyl sulfate, ammonium alkyl sulfate, alkyl ether sulfates, polycarboxylates, sodium lignosulfonate, sodium naphthalene sulfonate formaldehyde condensate, sodium xylene sulfonate, ammonium xylene sulfonate or mixtures thereof.

### Amphoteric Surfactants

When present, the amphoteric surfactants can be selected from amine oxides, betaines or mixtures thereof.

### Low-Mole Alkoxylate

The inventive compositions include a low-mole alkoxylate that differs in composition from the nonionic surfactant.

The low-mole alkoxylate has the formula:

R—O-(AO)ₚH

wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3. The low-mole alkoxylate can include mixtures of the low-mole alkoxylate of the above formula.

In some aspects, preferably, R is branched. In some aspects, the low-mole alkoxylate has an average of 0.6 to 2, or 0.8 to 1.2, or about 1 PO units per molecule and an average of 0 to 1, or 0 to 0.5, or 0 to 0.1 EO units per molecule. In some aspects, R is a linear or branched C₉-C₁₄ alkyl group or a linear or branched C₁₀-C₁₄ alkyl group, or a linear or branched C₁₀-C₁₃ alkyl group, or a linear or branched C₁₀-C₁₂ alkyl group or a linear or branched C₁₀-C₁₁ alkyl group or a linear or branched C₁₀ alkyl group.

In some aspects, the low-mole alkoxylate has the formula:

R—O—(PO)ₘ(EO)ₙH

wherein R is a linear or branched C₈-C₁₆ alkyl group, PO is oxypropylene, EO is oxyethylene, m has an average value within the range of 0.5 to 4, and n has an average value within the range of 0 to 1. In other aspects, m has an average value within the range of 0.6 to 2, 0.8 to 1.2, or about 1, and n has an average value within the range of 0 to 0.5, or within the range of 0 to 0.1.

In some aspects, the low-mole alkoxylate has the formula:

R—O-(EO)ₙ(PO)ₘH

wherein R is a linear or branched C₈-C₁₆ alkyl group, EO is oxyethylene, PO is oxypropylene, n has an average value within the range of 0 to 1, and m has an average value within the range of 0.5 to 4. In other aspects, n has an average value within the range of 0 to 0.5, or within the range of 0 to 0.1, and m has an average value within the range of 0.6 to 2, 0.8 to 1.2, or about 1. In some aspects, the low-mole alkoxylate has only oxypropylene (and no oxyethylene) units. Thus, in some aspects, the low-mole alkoxylate has the formula:

R—O—(PO)ₘH

wherein R is a linear or branched C₈-C₁₆ alkyl group, PO is oxypropylene, and m has an average value within the range of 0.5 to 4, 0.6 to 2, 0.8 to 1.5, or 0.9 to 1.2. In other aspects, m is preferably about 1. In a preferred aspect, R is a branched C₁₀-C₁₃ alkyl group.

The low-mole alkoxylate has an average of about 1 PO unit per molecule and an average of 0 to 1, 0 to 0.5, or 0 to 0.1 EO units per molecule.

In another embodiment, the low mole alkoxylate is preferably DA-1PO-1EO or DA-1PO-3EO, where DA stands for isodecyl alcohol (all isomers), -1PO means one propoxyl unit is attached to the isodecyl alcohol, and -1EO means one ethoxyl unit is attached to the propoxyl unit which is attached to the isodecyl alcohol, -3EO means three ethoxyl units are attached to the propoxyl unit which is attached to the isodecyl alcohol. For example, DA-1PO-1EO is isodecyl alcohol reacted with one mole of propylene oxide and then with one mole of ethylene oxide.

### Solvents

The solvents used in the agricultural compositions can include water, aqueous-based solvents, an organic solvent selected from aromatics, amides, alcohols, esters, dimethyl sulfoxide, petroleum distillates, n-methyl-2-pyrrolidone diethylene glycol, or a glycol ether, a vegetable oil, a seed oil, a tall oil fatty acid, or combinations thereof. Preferably, the seed oil is selected from sunflower oil, cottonseed oil, safflower oil, sesame seed oil, canola oil, grapeseed oil, flaxseed oil, soybean oil, or mixtures thereof. More preferably, the seed oil is soybean oil. Preferably, the vegetable oil is selected from almond oil, argan oil, avocado oil, canola oil, avocado oil, canola oil, coconut oil, cocoa butter, corn oil, lemon oil, linseed oil, orange oil, olive oil, palm oil, peanut oil or walnut oil, or mixtures thereof.

### Actives

The actives in the agricultural compositions can include herbicides, fungicides, insecticides or nematicides useful for application to foliar surfaces, soil, or plant roots. Herbicides are chemicals used to manipulate or control undesirable vegetation. Such applications include row-crop farming, where they are applied before or during planting to maximize crop productivity by minimizing other vegetation that competes for nutrients and sunlight. Typical herbicides include carfentrazone, glufosinate, glyphosate, thiobencarb, clethodim, s-metolachlor, metribuzin, octanoic acid ester of bromoxynil, trifluralin, ethalfluralin, dithiopyr, propanil, mesotrione, fomesafen, and quizalofop-p-ethyl.

Fungicides are a specific type of pesticide that controls fungal disease by specifically inhibiting or killing the fungus causing the disease. They are used to control diseases during the establishment and development of a crop with increased productivity by reducing blemishes, and improving the storage life and quality of harvested plants and produce. Typical fungicides include azoxystrobin, propiconazole, caprylic acid, myclobutanil, etridiazole, cyproconazole, and mefenoxam.

Insecticides are chemicals used to control insects by killing them or preventing them from engaging in undesirable or destructive behaviors. Typical insecticides include permethrin, abamectin, bifenthrin, deltramethrin, lambdacyhalothrin, pyriproxyfen, cypermethrin, fenpropathrin, dimethoate, and malathion.

Nematicides are chemical pesticides used to kill plant-parasitic nemotodes, i.e., parasitic worms such as roundworms and threadworms. Nematicides are typically broad-spectrum toxicants possessing high volatility or other properties promoting migration through the soil. Typical nematicides include 1,3-dichloropropene, and ethoprop.

Recommended use rates, or low and high levels for application of actives, have been established for each active by its manufacturer on the product's specimen label.

In one embodiment a composition suitable for an in-can agricultural formulation comprises: (a) 0.1 to 30.0 wt. % of a surfactant; (b) 0.5 to 90.0 wt. % of an active selected from herbicides, fungicides, insecticides or nematicides; (c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and (d) 1.0 to 95.0 wt. % of a low-mole alkoxylate of the formula:

R—O-(AO)ₚH

wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Preferably, the composition comprises: (a) 0.2 to 20.0 wt. % of the surfactant; (b) 5.0 to 75.0 wt. % of the active; (c) 2.0 to 30.0 wt. % of the solvent; and (d) 2.0 to 60.0 wt. % of the low-mole alkoxylate. More preferably, the composition comprises: (a) 0.5 to 20.0 wt. % of the surfactant; (b) 10.0 to 60.0 wt. % of the active; (c) 5.0 to 20.0 wt. % of the solvent; and (d) 3.0 to 50.0 wt. % of the low-mole alkoxylate.

Preferably, the surfactant is selected from nonionic, amphoteric or anionic surfactants. More preferably, the surfactant is a nonionic surfactant. When the surfactant is a nonionic surfactant, the nonionic surfactant is preferably selected from the group consisting of alkoxylated alcohols, fatty alcohol ethoxylates, ethoxylated alkanolamides, ethoxylated alkylphenols, ethoxylated styrylphenols, fatty amine ethoxylates, EO/PO block copolymers, ethoxylated castor oils, methyl ester ethoxylates, alkylpolyglucosides, polysorbates, fatty acid ethoxylates, and modified versions thereof in which one or more terminal hydroxyl groups is capped as an ether, ester, or halide. Preferably, the nonionic surfactant is an alkoxylated alcohol.

When the nonionic surfactant is an alkoxylated alcohol, the alkoxylated alcohol preferably has the formula:

R¹—O-(AO)_{q}H

wherein R¹ is a linear or branched C₈-C₁₆ alkyl group, AO is oxyethylene, oxypropylene, or combinations thereof in random or block configuration, and q has an average value within the range of 3 to 50. Preferably, the AO in the alkoxylated alcohol is oxyethylene and q has an average value within the range of 3 to 20.

Preferably, the low-mole alkoxylate has the formula:

R—O—(PO)ₘ(EO)ₙH

wherein R is a linear or branched C₈-C₁₆ alkyl group, PO is oxypropylene, EO is oxyethylene, m has an average value within the range of 0.5 to 4, and n has an average value within the range of 0 to 1. Preferably, m has an average value within the range of 0.8 to 1.5 and n has an average value within the range of 0 to 0.5. Preferably, R is a branched C₁₀-C₁₃ alkyl group.

In another embodiment, an in-tank agricultural composition comprises: (a) 10.0 to 85.0 wt. % of a surfactant; (b) 5.0 to 40.0 wt. % of a solvent selected from water, an aqueous-based solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and (c) 10.0 to 70.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Preferably, the composition comprises 20.0 to 80.0 wt. % of the surfactant; 10.0 to 30.0 wt. % of the solvent; and 10.0 to 65.0 wt. % of the low-mole alkoxylate. More preferably, the composition comprises 30.0 to 75.0 wt. % of the surfactant; 10.0 to 25.0 wt. % of the solvent; and 15.0 to 60.0 wt. % of the low-mole alkoxylate. In other preferred embodiments, the composition comprises 25.0 to 60.0 wt. % of the surfactant, 30.0 to 50.0 wt. % of the low mole alkoxylate, and 10.0 to 25.0 wt. % of the solvent; or the composition comprises 25.0 to 40.0 wt. % of the surfactant, 35.0 to 50.0 wt. % of the low mole alkoxylate, and 20.0 to 25.0 wt. % of the solvent.

Preferably, the surfactant is selected from nonionic, amphoteric or anionic surfactants. More preferably, the surfactant is a nonionic surfactant.

Preferably, the nonionic surfactant is selected from the group consisting of alkoxylated alcohols, fatty alcohol ethoxylates, ethoxylated alkanolamides, ethoxylated alkylphenols, ethoxylated styrylphenols, fatty amine ethoxylates, EO/PO block copolymers, ethoxylated castor oils, methyl ester ethoxylates, alkylpolyglucosides, polysorbates, fatty acid ethoxylates. Preferably, the nonionic surfactant is an alkoxylated alcohol. When the nonionic surfactant is an alkoxylated alcohol, the alkoxylated alcohol preferably has the formula:

R¹—O-(AO)_{q}H
wherein R¹ is a linear or branched C₈-C₁₆ alkyl group, AO is oxyethylene, oxypropylene, or combinations thereof in random or block configuration, and q has an average value within the range of 3 to 50. Preferably, the AO in the alkoxylated alcohol is oxyethylene and q has an average value within the range of 3 to 20.

Preferably, the solvent is water or is selected from diethylene glycol, vegetable oil, seed oil, or tall oil fatty acids or combinations thereof.

### Methods

Agricultural formulations typically take the form of emulsion concentrates (EC), suspension concentrates (SC), soluble liquids (SL), and combinations thereof. An inventive method comprises forming an agricultural mixture by combining: (a) 0.1 to 30.0 wt. % of a surfactant; (b) 0.5 to 90.0 wt. % of an active selected from herbicides, fungicides, insecticides or nematicides; (c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and (d) 1.0 to 95.0 wt. % of a low-mole alkoxylate of the formula:

R—O-(AO)ₚH

wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Still another inventive method comprises forming an agricultural mixture by combining: (a) 10.0 to 85.0 wt. % of a surfactant; (b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and (c) 10.0 to 70.0 wt. % of a low-mole alkoxylate of the formula:

R—O-(AO)ₚH

wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

Another inventive method comprises forming a sprayable mixture by combining: (a) 0.1 to 30.0 wt. % of a surfactant; (b) 0.5 to 90.0 wt. % of an active selected from herbicides, fungicides, insecticides or nematicides; (c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and (d) 1.0 to 95.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3; and diluting the mixture by at least 50% with water.

Another inventive agricultural method comprises: forming a mixture by combining: (a) 10.0 to 85.0 wt. % of a surfactant; (b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and (c) 10.0 to 70.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3;
adding an active to the mixture to form a sprayable mixture; and
optionally diluting the resulting composition by at least 50% with water.

### Applications

The inventive compositions and aqueous solutions containing them are useful in agricultural applications.

An inventive agricultural application comprises applying a sprayable composition to foliar surfaces, soil, or plant roots, wherein the sprayable composition comprises a mixture comprising: (a) 0.1 to 30.0 wt. % of a surfactant; (b) 0.5 to 90.0 wt. % of an active selected from herbicides, fungicides, insecticides or nematicides; (c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and (d) 1.0 to 95.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3, and wherein the mixture has been diluted by at least 50% with water.

Still another inventive agricultural application comprises: applying a sprayable composition to foliar surfaces, soil, or plant roots, wherein the sprayable composition comprises a mixture comprising: (a) 10.0 to 85.0 wt. % of a surfactant; (b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and (c) 10.0 to 70.0 wt. % of a low-mole alkoxylate of the formula:

R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3,
wherein an active has been added to the mixture, and the resultant composition has optionally been diluted by at least 50% with water.

The following examples merely illustrate the inventive subject matter. Many similar variations within the scope of the claims will immediately be apparent to those skilled in the art.

### Product Stability

### Reduced Temperature

Tank mix (delivery) formulations are stored at reduced (4° C.) temperatures for 4 weeks, where the reduced temperatures mimic long term storage in cold environments [CIPAC MT 39.3 Low Temperature Stability of Liquid Formulations.] All samples are then checked for freeze point and for pour point using an ISL MPP-5Gs Analyzer (equivalent to ASTM D97). Pour point and freeze point measurement is an indication of the utility of the product at low temperatures. Results of the pour point and freeze point measurements are shown in Table 1.

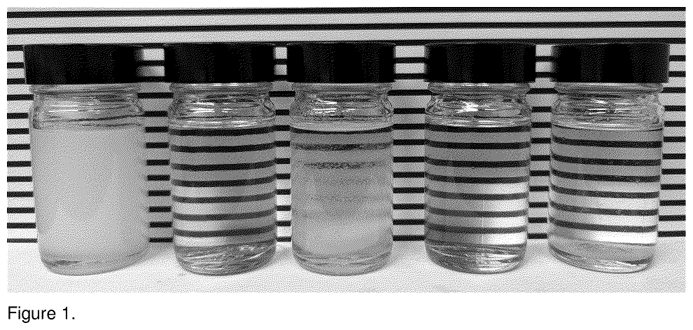

Photographs were also taken of the samples immediately after removal from the reduced temperature storage, and are shown as FIG. 1 in the following order left to right: Control Example 1 and Examples 6, 4, 5, 3, where the increased opaqueness in Control Example 1 indicates increased viscosity.

TABLE 1

| | Percent | Percent | | | Pour | Freeze |
|---|---|---|---|---|---|---|
| | BIO-SOFT ® | DA-1PO- | Percent | Percent | Point, | Point, |
| | N25-7¹ | 1EO² | Soybean Oil | Water | ° C. | ° C. |
| Control | 75.0 | 0.0 | 15.0 | 10.0 | 3.0 | 2.2 |
| Example 1 | | | | | | |
| Example 3 | 55.0 | 20.0 | 15.0 | 10.0 | −3.0 | −5.8 |
| Example 4 | 60.0 | 30.0 | 0.0 | 10.0 | −3.0 | −5.6 |
| Example 5 | 25.0 | 50.0 | 15.0 | 10.0 | −18.0 | −19.3 |
| Example 6 | 30.0 | 60.0 | 0.0 | 10.0 | −18.0 | −20.7 |

¹BIO-SOFT ® N25-7 is a C₁₂-C₁₅ linear alcohol ethoxylate surfactant commercially available from Stepan Company.
²DA-1PO-1EO was produced by reacting EXXAL ® 10 (isodecyl alcohol), product of ExxonMobil with one mole of propylene oxide followed by one mole of ethylene oxide using a KOH catalyst. The product is neutralized with acetic acid.

### Elevated, Reduced (with Freeze/Thaw Cycles) & Ambient Temperatures

Examples 3, 5, 4, and 6 were further stored at elevated (54° C.), reduced (4° C.), and ambient (20° C.+/−2° C.) temperatures for 2 weeks, as well as 5 freeze/thaw cycles [CIPAC MT 46.3 Accelerated Storage Procedure.] All samples are then checked for appearance and temperature stability. Elevated temperatures are used to test for accelerated aging of the product, reduced temperatures mimic long term storage in cold environments, freeze/thaw determines if a formulation is unstable after freezing and thawing multiple times, and ambient is the control group (as well as day 0 analysis). Results are shown in Table 2.

TABLE 2

| | Appearance | Product Stability |
|---|---|---|
| Example 3 | Clear/pale | Product is stable at: |
| | yellow, free- | 20° C. (5 freeze/thaw) |
| | flowing | 4° C. (2 weeks) |
| | material | 54°(2 weeks) |
| Example 4 | Clear, free- | Product is stable at: |
| | flowing | 20° C. (5 freeze/thaw) |
| | material | 4° C. (2 weeks) |
| | | 54°(2 weeks) |
| Example 5 | Clear/pale | Product is stable at: |
| | yellow, free- | 20° C. (5 freeze/thaw) |
| | flowing | 4° C. (2 weeks) |
| | material | 54°(2 weeks) |
| Example 6 | Clear, free- | Product is stable at: |
| | flowing | 20° C. (5 freeze/thaw) |
| | material | 4° C. (2 weeks) |
| | | 54°(2 weeks) |

The results shown in Table 1, FIG. 1, and Table 2 indicate that the inventive materials possess temperature stability, and are suitable for formulation into freeze/thaw stable agricultural formulations. The testing demonstrates their utility at low temperatures, which is desirable in commercial applications.

### Defoaming

Mechanical Shake Foam experiments were conducted with Control Examples 1 and 11, and the inventive formulations of Examples 3, 8-10, and 12-14. The samples were diluted to 100 g with water (D.I. or desired water hardness of 50 ppm) in a 500 mL graduated cylinder. The shake foam machine then inverts the cylinder 10 times and volume or height of foam is measured at 15 seconds and 5 minutes.

Properties of the materials and results of the defoaming experiments are shown in Table 3A.

TABLE 3A

| | BIO- | | % | | Initial Foam | Foam Height at 5 |
|---|---|---|---|---|---|---|
| | SOFT ® | % DA- | Soybean | | Height (mL), Avg, | minutes (mL), Avg., |
| | N25-7¹ | 1PO-1EO | Oil | % Water | N = 2 | N = 2 |
| Control | 75 | 0 | 15 | 10 | 250 | 240 |
| Example 1 | | | | | | |
| Example 3 | 55 | 20 | 15 | 10 | 137.5 | 132.5 |
| Example 9 | 40 | 35 | 15 | 10 | 125 | 120 |
| Example 10 | 25 | 50 | 15 | 10 | 122.5 | 117.5 |
| Control | 90 | 0 | 0 | 10 | 395 | 357.5 |
| Example 11 | | | | | | |
| Example 12 | 75 | 15 | 0 | 10 | 252.5 | 235 |
| Example 13 | 60 | 30 | 0 | 10 | 145 | 135 |
| Example 14 | 45 | 45 | 0 | 10 | 122.5 | 115 |
| Example 8 | 30 | 60 | 0 | 10 | 122.5 | 112.5 |

These results indicate that the inventive compositions demonstrate reduced foaming in agricultural formulations.

### Reduced Contact Angle Testing

A series of compositions were prepared containing surfactants, low-mole alkoxylate and solvents, as delivery systems. These compositions are shown in Table 3B. The tank mix (delivery systems) are then combined with an active (mesotrione or quizalofop-p-ethyl) at the recommended high and low levels for these herbicides, as shown in Tables 4 and 5 respectively. The resultant solutions were then diluted with water for reduced contact angle testing, as shown in Tables 4 and 5. Reduced contact angle measurements reflect improved wetting ability of the solutions.

TABLE 3B

| | BIO-SOFT ® | Surfactant | DA-1PO- | Soybean | | |
|---|---|---|---|---|---|---|
| | N25-7/% | blend/%¹ | 1EO/% | oil/% | Water/% | Active/% |
| Control | 75 | 0 | 0 | 15 | 10 | 0 |
| Example 1 | | | | | | |
| Example 2 | 65 | 0 | 10 | 15 | 10 | 0 |
| Example 3 | 55 | 0 | 20 | 15 | 10 | 0 |
| Example 4 | 60 | 0 | 30 | 0 | 10 | 0 |
| Example 5 | 25 | 0 | 50 | 15 | 10 | 0 |
| Example 6 | 30 | 0 | 60 | 0 | 10 | 0 |
| Control | 0 | 90 | 0 | 0 | 10 | 0 |
| Example 7A | | | | | | |
| Example 7B | 0 | 75 | 15 | 0 | 10 | 0 |
| Example 8 | 30 | 0 | 60 | 0 | 10 | 0 |
| Example 9 | 40 | 0 | 35 | 15 | 10 | 0 |
| Example 10 | 25 | 0 | 50 | 15 | 10 | 0 |
| Control | 90 | 0 | 0 | 0 | 10 | 0 |
| Example 11 | | | | | | |
| Control 15 | 0 | 0 | 0 | 0 | >99 | Per |
| | | | | | | label |

¹Activator 90, commercially available from Loveland Products

Contact angle measurements were performed on a Parafilm® surface using a Krüss DSA100 drop shape analysis instrument. High speed video of the first 30 seconds of wetting was obtained and analyzed using the Ellipse (Tangent-1) algorithm. The last 15 seconds of contact angle measurements were averaged to determine the quasi-equilibrium sessile drop contact angle.

### Mesotrione as Active

The herbicide mesotrione was tested with various levels of low-mole alkoxylate and the surfactant BIO-SOFT N25-7 in the delivery compositions. Experimental controls of the herbicide in water as well as in the tank mix formulation, in the absence of low-mole alkoxylate, were also tested. Results of the reduced contact angle testing are shown in Table 4.

TABLE 4

| | 0.25% v/v sample | Contact | | Δ contact angle |
|---|---|---|---|---|
| Mesotrione | in 50 ppm | Angle/ | std. | from Control |
| active/% v/v | hardness | ° | dev. | Example 1 |
| 0.048 | Control 15 | 95.87 | 1.22 | — |
| 0.24 | Control 15 | 91.46 | 0.75 | — |
| 0.048 | Control Example 1 | 49.21 | 1.06 | — |
| 0.24 | Control Example 1 | 50.34 | 1.12 | — |
| 0.048 | Example 2 | 45.18 | 0.74 | 4.03 |
| 0.24 | Example 2 | 44.65 | 0.67 | 5.69 |
| 0.048 | Example 3 | 42.43 | 0.52 | 6.78 |
| 0.24 | Example 3 | 42.32 | 0.59 | 8.02 |
| 0.048 | Example 4 | 38.98 | 0.82 | 10.23 |
| 0.24 | Example 4 | 39.42 | 0.44 | 10.92 |
| 0.048 | Example 5 | 38.38 | 0.80 | 10.83 |
| 0.24 | Example 5 | 39.18 | 0.76 | 11.16 |
| 0.048 | Example 6 | 36.96 | 1.04 | 12.25 |
| 0.24 | Example 6 | 38.05 | 0.77 | 12.29 |

The increasing substitution of low-mole alkoxylate for the nonionic surfactant (Ex. 2-6) results in considerable wetting improvement relative to the control, up to a 12° decrease in the contact angle on Parafilm.

### Quizalofop-p-ethyl as Active

The herbicide quizalofop-p-ethyl was tested with the same formulations as in Table 3B. Experimental controls of the herbicide in water as well as the tank mix formulation in the absence of low-mole alkoxylate were also tested. Results are shown in Table 5.

TABLE 5

| | | | | Δ contact |
|---|---|---|---|---|
| Quizalofop-p- | 0.25% v/v sample | | | angle from |
| ethyl active/% | in 50 ppm | Contact | std. | Control |
| v/v | hardness | Angle/° | dev. | Example 1 |
| 0.02678 | Example 3 | 45.43 | 0.85 | 2.09 |
| 0.05356 | Example 3 | 47.84 | 0.63 | 2.28 |
| 0.02678 | Example 4 | 45.22 | 0.66 | 2.30 |
| 0.05356 | Example 4 | 47.80 | 0.64 | 2.32 |
| 0.02678 | Example 5 | 43.97 | 0.95 | 3.55 |
| 0.05356 | Example 5 | 45.74 | 0.70 | 4.38 |
| 0.02678 | Example 6 | 42.17 | 0.86 | 5.35 |
| 0.05356 | Example 6 | 44.38 | 0.82 | 5.75 |
| 0.02678 | Control 15 | 64.74 | 4.17 | |
| 0.05356 | Control 15 | 57.52 | 1.45 | |
| 0.02678 | Control Example 1 | 47.52 | 0.52 | 0 |
| 0.05356 | Control Example 1 | 50.12 | 1.05 | 0 |

The substitution of the low-mole alkoxylate for the nonionic surfactant in the delivery system resulted in wetting improvement up to a 5° contact angle on Parafilm relative to the control.

### Mesotrione or Quizalofop-p-ethyl as Active

Samples were prepared using a mixed surfactant (Activator 90 by Loveland) with mesotrione or quizalofop-p-ethyl as actives. For both actives, present in high and low levels, as indicated in Table 7, a composition of mixed surfactant and water (Control Example 7A) is compared to a delivery system containing the mixed surfactant, a low-mole alkoxylate, and water (Example 7B). The compositions were diluted as indicated and the contact angle testing conducted. Reduced contact angle results for the compositions are summarized in Table 7. These demonstrate that the wetting of Parafilm by Example 7B improved contact angle results relative to the comparative formulation Control Example 7A for both actives.

TABLE 7

| | | | | Δ contact |
|---|---|---|---|---|
| herbicide/ | | Contact | std. | angle from |
| % v/v | 0.25% v/v in 50 ppm hardness | Angle/° | dev. | Control Ex. 7A |
| 0.12 | Control Example 7A (mesotrione) | 58.10 | 0.82 | — |
| 0.6 | Control Example 7A (mesotrione) | 58.30 | 0.73 | — |
| 0.12 | Example 7B (mesotrione) | 52.16 | 1.50 | 5.94 |
| 0.6 | Example 7B (mesotrione) | 50.00 | 2.15 | 8.31 |
| 0 | Control Example 7A | 57.78 | 1.20 | — |
| 0 | Example 7B | 50.24 | 0.90 | 7.53 |
| 0.26 | Control Example 7A (quizalofop-p- | 53.66 | 1.55 | — |
| | ethyl) | 50.28 | 0.99 | — |
| 0.52 | Control Example 7A (quizalofop-p- | | | |
| | ethyl) | | | |
| 0.26 | Example 7B (quizalofop-p-ethyl) | 50.81 | 0.86 | 2.84 |
| 0.52 | Example 7B (quizalofop-p-ethyl) | 49.58 | 0.84 | 0.70 |

### Fomesafen as Active

The herbicide fomesafen was tested with tank mix formulations that contained low-mole alkoxylate and the surfactant BIO-SOFT N25-7. The samples were then diluted and contact angle testing conducted. Levels of fomesafen and dilution used are listed in Table 8. Experimental controls of the herbicide in water as well as the tank mix formulation in the absence of low-mole alkoxylate were also tested. The contact angle reduction results are shown in Table 8.

TABLE 8

| | | | | Δ contact |
|---|---|---|---|---|
| Fomesafen | | | | angle from |
| active/% | 0.25% v/v in 50 | Contact | std. | Control |
| v/v | ppm hardness | Angle/° | dev. | Example 1 |
| 0.1176 | Control 15 | 58.93 | 0.93 | — |
| 0.504 | Control 15 | 55.37 | 0.55 | — |
| 0.1176 | Control Example 1 | 52.23 | 0.82 | — |
| 0.504 | Control Example 1 | 55.08 | 0.62 | — |
| 0.1176 | Example 2 | 48.53 | 0.94 | 3.71 |
| 0.504 | Example 2 | 52.37 | 0.49 | 2.71 |

The results of Table 8 demonstrate that the inclusion of low mole alkoxylate in agricultural formulations reduces the contact angle of 0.25% solutions of these formulations on Parafilm relative to the control formulations.

The preceding examples are meant only as illustrations; the following claims define the scope of the invention.

We claim:

1. A composition comprising:
(a) 0.1 to 30.0 wt. % of a surfactant;
(b) 0.5 to 90.0 wt. % of an active selected from herbicides, fungicides, insecticides or nematicides;
(c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and
(d) 1.0 to 95.0 wt. % of a low-mole alkoxylate of the formula:
R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

2. The composition of claim 1 wherein the surfactant is selected from nonionic, amphoteric or anionic surfactants.

3. The composition of claim 2 wherein the surfactant is a nonionic surfactant.

4. The composition of claim 3 wherein the nonionic surfactant is selected from the group consisting of alkoxylated alcohols, fatty alcohol ethoxylates, ethoxylated alkanolamides, ethoxylated alkylphenols, ethoxylated styrylphenols, fatty amine ethoxylates, EO/PO block copolymers, ethoxylated castor oils, methyl ester ethoxylates, alkylpolyglucosides, polysorbates, fatty acid ethoxylates, and modified versions thereof in which one or more terminal hydroxyl groups is capped as an ether, ester, or halide.

5. The composition of claim 4 wherein the nonionic surfactant is an alkoxylated alcohol.

6. The composition of claim 5 wherein the alkoxylated alcohol has the formula:
R¹—O-(AO)_{q}H
wherein R¹ is a linear or branched C₈-C₁₆ alkyl group, AO is oxyethylene, oxypropylene, or combinations thereof in random or block configuration, and q has an average value within the range of 3 to 50.

7. The composition of claim 6 wherein AO in the alkoxylated alcohol is oxyethylene and q has an average value within the range of 3 to 20.

8. The composition of claim 1 comprising:
(a) 0.2 to 20.0 wt. % of the surfactant
(b) 5.0 to 75.0 wt. % of the active;
(c) 2.0 to 30.0 wt. % of the solvent; and
(d) 2.0 to 60.0 wt. % of the low-mole alkoxylate.

9. The composition of claim 8 comprising:
(a) 0.5 to 20.0 wt. % of the surfactant
(b) 10.0 to 60.0 wt. % of the active;
(c) 5.0 to 20.0 wt. % of the solvent; and
(d) 3.0 to 50.0 wt. % of the low-mole alkoxylate.

10. The composition of claim 1 wherein the low-mole alkoxylate has the formula:
R—O—(PO)ₘ(EO)ₙH
wherein R is a linear or branched C₈-C₁₆ alkyl group, PO is oxypropylene, EO is oxyethylene, m has an average value within the range of 0.5 to 4, and n has an average value within the range of 0 to 1.

11. The composition of claim 10 wherein m has an average value within the range of 0.8 to 1.5 and n has an average value within the range of 0 to 0.5.

12. The composition of claim 10 wherein R is a branched C₁₀-C₁₃ alkyl group.

13. A composition comprising:
(a) 10.0 to 85.0 wt. % of a surfactant;
(b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and
(c) 10.0 to 70.0 wt. % of a low-mole alkoxylate of the formula:
R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

14. The composition of claim 13 comprising:
(a) 20.0 to 80.0 wt. % of the surfactant
(b) 10.0 to 30.0 wt. % of the solvent;
(c) 10.0 to 65.0 wt. % of the low-mole alkoxylate.

15. The composition of claim 14 comprising:
(a) 30.0 to 75.0 wt. % of the surfactant
(b) 10.0 to 25.0 wt. % of the solvent;
(c) 15.0 to 60.0 wt. % of the low-mole alkoxylate.

16. The composition of claim 13 wherein the surfactant is selected from nonionic, amphoteric or anionic surfactants.

17. The composition of claim 16 wherein the surfactant is a nonionic surfactant.

18. The composition of claim 13 wherein the solvent is water.

19. The composition of claim 13 wherein the solvent is selected from diethylene glycol, vegetable oil, the seed oil, or the tall oil fatty acid or combinations thereof.

20. The composition of claim 17 wherein the nonionic surfactant is selected from the group consisting of alkoxylated alcohols, fatty alcohol ethoxylates, ethoxylated alkanolamides, ethoxylated alkylphenols, ethoxylated styrylphenols, fatty amine ethoxylates, EO/PO block copolymers, ethoxylated castor oils, methyl ester ethoxylates, alkylpolyglucosides, polysorbates, fatty acid ethoxylates.

21. The composition of claim 20 wherein the nonionic surfactant is an alkoxylated alcohol.

22. The composition of claim 21 wherein the alkoxylated alcohol has the formula:
R¹—O-(AO)_{q}H
wherein R¹ is a linear or branched C₈-C₁₆ alkyl group, AO is oxyethylene, oxypropylene, or combinations thereof in random or block configuration, and q has an average value within the range of 3 to 50.

23. The composition of claim 22 wherein AO in the alkoxylated alcohol is oxyethylene and q has an average value within the range of 3 to 20.

24. A method to produce a sprayable composition comprising diluting the composition of claim 1 by at least 50% with water.

25. A method comprising applying the sprayable composition of claim 24 to foliar surfaces, soil, or plant roots.

26. A method to produce a sprayable composition comprising combining the composition of claim 1 with an active selected from herbicides, fungicides, insecticides or nematicides.

27. A method comprising applying the sprayable composition of claim 26 to foliar surfaces, soil, or plant roots.

28. A method comprising forming a mixture by combining:
(a) 0.1 to 30.0 wt. % of a surfactant;
(b) 0.5 to 90.0 wt. % of an active selected from herbicides, fungicides, insecticides or nematicides;
(c) 1.0 to 40.0% of a solvent selected from an aqueous solvent, an organic solvent selected from aromatics, amides, alcohols, esters, dimethyl sulfoxide, petroleum distillates, n-methyl-2-pyrrolidone or combinations thereof; and
(d) 1.0 to 95.0 wt. % of a low-mole alkoxylate of the formula:
R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

29. A method comprising forming a mixture by combining:
(a) 10.0 to 85.0 wt. % of a surfactant;
(b) 5.0 to 40.0 wt. % of a solvent selected from an aqueous solvent, an organic solvent selected from aromatics, amides, alcohols, esters, dimethyl sulfoxide, petroleum distillates, n-methyl-2-pyrrolidone, diethylene glycol, or a glycol ether, a vegetable oil, a seed oil, a tall oil fatty acid, or combinations thereof; and
(c) 10.0 to 70.0 wt. % of a low-mole alkoxylate of the formula:
R—O-(AO)ₚH
wherein R is a linear or branched C₈-C₁₆ alkyl group, AO is oxypropylene (PO), oxyethylene (EO), or combinations thereof in random or block configuration, p has an average value within the range of 0.5 to 7, the average number of PO groups is within the range of 0.5 to 4, and the average number of EO groups is within the range of 0 to 3.

30. The composition of claim 13 wherein the seed oil is selected from sunflower oil, cottonseed oil, safflower oil, sesame seed oil, canola oil, grapeseed oil, flaxseed oil, soybean oil, or mixtures thereof.

31. The composition of claim 13 wherein the vegetable oil is selected from almond oil, argan oil, avocado oil, canola oil, avocado oil, canola oil, coconut oil, cocoa butter, corn oil, lemon oil, linseed oil, orange oil, olive oil, palm oil, peanut oil or walnut oil or mixtures thereof.
